(19) United States
(12) Patent Application Publication
(10) Pub. No.: US 2002/0136410 A1
(43) Pub. Date: Sep. 26, 2002

(54) Method and apparatus for extinguishing ephemeral keys

(75) Inventor: Stephen R. Hanna, Bedford, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: Sun Microsystems, Inc.

(21) Appl. No.: 09/817,543

(22) Filed: Mar. 26, 2001

(51) Int. Cl. H04L 9/00

(52) U.S. Cl. 380/277

(57) ABSTRACT

A method and apparatus for performing ephemeral communication and assuring that an ephemeral decryption key is not accessible subsequent to an expiration time associated with the respective key. An ephemeral key pair is preferably generated within a tamper resistant cryptographic processor unit. The ephemeral key pair comprises and ephemeral encryption key and an ephemeral decryption key. The ephemeral decryption key is prevented from being accessed external of the tamper resistant cryptographic processor unit. Ephemeral messages encrypted using an ephemeral encryption key are decrypted by the cryptographic processor unit if associated with a time that precedes the expiration time for the respective ephemeral decryption key. A decrypted ephemeral message is prevented from being transmitted from the cryptographic processor unit in the event a time associated with a received encrypted ephemeral message is subsequent to the expiration time for the respective ephemeral key pair.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention relates to methods and apparatus for assuring data security and more specifically, to techniques for extinguishing ephemeral keys to prevent encrypted information from being decrypted using an ephemeral key following a predetermined expiration time for the respective ephemeral key.

In recent years, individuals and businesses have increasingly employed computer and telecommunications networks, such as the World Wide Web (WWW), to exchange messages. These networks typically include a number of intermediate systems between the source of a message and its destination, at which the message may be temporarily written to a memory and/or data storage device. Such intermediate systems, as well as the communications lines within the network itself, are often considered to be susceptible to actions of a malicious third party, which may result in messages being intercepted as they are carried through the network. For this reason, various types of data encryption have been used for private communications through such networks. Encryption algorithms are also sometimes used to support integrity checking and authentication of received messages. Integrity checking allows the message recipient to determine whether the message has been altered since it was generated, while authentication permits the recipient to verify the source of the message.

Specific encryption algorithms are usually thought of as being either “symmetric key” or “public key” systems. In symmetric key encryption, also sometimes referred to as “secret key” encryption, the two communicating parties use a shared, secret key to both encrypt and decrypt messages they exchange. The Data Encryption Standard (DES), published in 1977 by the National Bureau of Standards, and the International Data Encryption Algorithm (IDEA), developed by Xuejia Lai and James L. Massey, are examples of well known symmetric key encryption techniques. Public key encryption systems, in contrast to symmetric key systems, provide each party with two keys: a private key that is not revealed to anyone, and a public key made available to everyone. When the public key is used to encrypt a message, the resulting encoded message can only be decoded using the corresponding private key. Public key encryption systems also support the use of “digital signatures”, which are used to authenticate the sender of a message. A digital signature is an encrypted digest associated with a particular message, which can be analyzed by a holder of a public key to verify that the message was generated by someone knowing the corresponding private key.

While encryption protects the encrypted data from being understood by someone not in possession of the decryption key, the longer such encrypted information is stored, the greater potential there may be for such a key to fall into the wrong hands. For example, key escrows are often maintained which keep records of past keys. Such records may be stored for convenience in order to recover encrypted data when a key has been lost, for law enforcement purposes, to permit the police to eavesdrop on conversations regarding criminal activities, or for business management to monitor the contents of employee communications. However, as a consequence of such long-term storage, the keys may be discovered over time.

In existing systems, there are various events that may result in an encrypted message remaining stored beyond its usefulness to a receiving party. First, there is no guarantee that a receiver of an encrypted message will promptly delete it after it has been read. Additionally, electronic mail and other types of messages may be automatically “backed-up” to secondary storage, either at the destination system, or even within intermediate systems through which they traverse. The time period such back-up copies are stored is sometimes indeterminate, and outside control of the message originator. Thus, it is apparent that even under ordinary circumstances, an encrypted message may remain in existence well beyond its usefulness, and that such longevity may result in the privacy of the message being compromised.

An example of a method and apparatus for providing for ephemeral decryption of information, messages and files is described in U.S. application Ser. No. 09/395,581 filed Sep. 14, 1999, titled “Ephemeral Decryptability”, which application is assigned to the assignee of the present invention. This application relies upon “ephemerizers” that maintain keys which expire at a predetermined time. By providing for the destruction of the decryption key at a predetermined time, the encrypted data cannot be recovered following the destruction of the decryption key. Even if an authorized user attempts to decrypt data after the expiration of the decryption key, the user will not be able to do so.

The integrity of systems employing ephemerizers relies on the ephemerizer's ability to destroy their ephemeral keys at the appropriate expiration time. In typical computer systems, however, it is not straightforward to assure that ephemeral keys are destroyed at the specified expiration time for a number of reasons. If the ephemeral keys are stored on typical non-volatile media such as magnetic hard disks or backed up on magnetic tape and the keys stored on the non-volatile media are overwritten or erased, the keys may be able to be recovered via forensic techniques. For example, residual magnetic charges on the disk or tape may be analyzed and the ephemeral keys recovered after the expiration date. The possible accessibility of the ephemeral keys after the expiration date in this circumstance can raise questions regarding the possible accessibility of encrypted data after the expiration date. To avoid this problem, ephemeral keys may be stored on a volatile storage device such as a random access memory. At the applicable time, the volatile storage device may be erased so as to assure that the ephemeral keys no longer recoverable. The use of volatile storage devices, however, runs the risk that the keys may be erased prematurely as the result of a power failure and that critical information, files and/or messages may become prematurely inaccessible.

It would therefore be desirable to have a system that can assure that ephemeral keys are maintained with a high degree of reliability until the expiration time for the respective keys and can be assured to be extinguished and/or unavailable following the expiration time.

### BRIEF SUMMARY OF THE INVENTION

A method and apparatus are disclosed for assuring that an ephemeral decryption key is not accessible following a predetermined expiration time. Consistent with the present invention, ephemeral encryption and decryption keys are stored in a tamper resistant cryptographic processor unit. The tamper resistant cryptographic processor unit prevents ephemeral decryption keys from being copied from the device and prevents the ephemeral keys from being changed to another value once written to a memory within the tamper resistant device. In one embodiment, the tamper resistant device causes the ephemeral keys to be irrevocably erased in response to an unauthorized attempt to access an ephemeral key or upon expiration of the respective ephemeral key. In an alternative embodiment, the tamper resistant device prevents an ephemeral decryption key from being accessed or prevents the ephemeral decryption key from being used to decrypt ephemeral messages following the expiration time for the respective key.

The ephemeral encryption keys may be distributed to authorized users however, the ephemeral decryption keys are securely maintained within the tamper resistant device. Upon reaching an expiration time for an ephemeral decryption key stored within the tamper resistant device, in a first embodiment, the decryption key is irrevocably destroyed leaving no forensic traces of the previously stored ephemeral decryption key value. In a second embodiment, the ephemeral decryption key is not destroyed. Rather, in response to a request for decryption of a message that would entail use of an ephemeral decryption key, a determination is made whether the request is subsequent to the expiration time associated with the respective ephemeral decryption key. In the event the request is subsequent to the expiration time associated with the respective ephemeral decryption key, access to the respective ephemeral decryption key is denied by the tamper resistant device. Additionally, in response to a request for access to the ephemeral decryption key following the associated expiration time for the key, the ephemeral decryption key may be destroyed.

Other features, aspects and advantages of the presently disclosed invention will be apparent from the Detailed Description of the Invention that follows.

### BRIEF DESCRIPTION OF THE SEVERAL VIEWS OF THE DRAWING

The invention will be more fully understood by reference to the following Detailed Description of the invention in conjunction with the Drawings of which:

FIG. 1 shows an ephemeral key pair list;

FIG. 2 shows an ephemeral message format used in a first illustrative embodiment of the invention;

FIG. 3 shows steps performed to generate and receive an ephemeral message in the first embodiment of the invention;

FIG. 4 shows several ephemerizers together with a number of user parties in a second illustrative embodiment of the invention;

FIG. 5 shows an ephemeral message format used in the second embodiment of the invention;

FIG. 6 shows steps performed to generate and process an ephemeral message in the second embodiment of the invention;

FIG. 7 shows an ephemeral message format which may be used when multiple ephemerizers are employed to perform multiple successive encryptions using ephemeral encryption keys;

FIG. 8 shows an ephemeral message format that may be used when multiple ephemerizers are employed to perform a K of N form of encryption;

FIG. 9 shows a first system employing a tamper resistant storage device for storing ephemeral key pairs in a manner consistent with the present invention;

FIG. 10 depicts a block diagram of an exemplary tamper resistant cryptographic processor unit 206 of the type depicted in FIG. 1;

FIG. 11 depicts a flow diagram illustrating a method of operation of the system depicted in FIG. 9 consistent with the present invention; and

FIG. 12 illustrates an ephemeral communication system in which one node serves as an ephemerizer and participates in ephemeral communications with a second node.

### DETAILED DESCRIPTION OF THE INVENTION

Consistent with the present invention, a system and method for providing ephemeral decryptability is disclosed which enables a user to ensure that encrypted messages will become undecryptable after a certain point in time. In one embodiment of the invention, ephemeral keys are generated and stored in a tamper resistance device such as a smart card. Use of the tamper resistant device for generation and storage of the ephemeral keys allows the system to assure that the ephemeral keys are irrevocably extinguished or made inaccessible following the expiration time for the respective ephemeral keys.

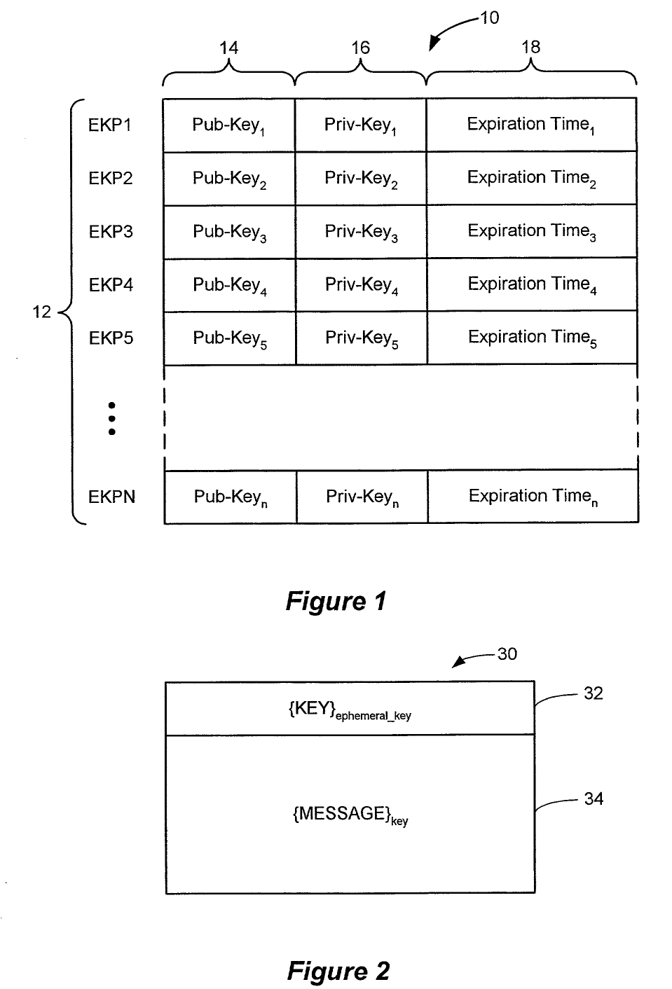

As shown in FIG. 1, an ephemeral key pair list includes a number of ephemeral key pairs 12. Each ephemeral key pair includes a public key part 14, a private key part 16, and an associated expiration time 18. The public key part 14 and associated expiration times 18 of the ephemeral key pairs may be read by parties wishing to use one or more of the ephemeral key pairs 12, but the private key part 16 of each ephemeral key is accessible only to the publisher of the ephemeral key list 12. As in conventional public key encryption techniques, data encrypted using one of the public keys 14 can only be decrypted using the private key 16 from the same ephemeral key pair. Each of the ephemeral key pairs 12 represents a promise by the publisher of the ephemeral key pair list 12 that the ephemeral key pair will be irretrievably destroyed at the associated expiration time.

FIG. 2 shows an illustrative ephemeral message format 30 employed in a first embodiment of the invention. The ephemeral message format 30 is shown including a message key portion 32, as well as a message body portion 34. The message key portion 32 contains a symmetric key, which itself has been encrypted by use of an ephemeral encryption key, such as either a public key from an ephemeral key pair, or an ephemeral symmetric key. The message portion 34 contains a message that has been encrypted using the symmetric key stored in the message key portion 32. Accordingly, in order to read the message in the message body portion 34, the symmetric key in the message key portion 32 must first be decrypted using the appropriate ephemeral decryption key, for example either a private key from the same ephemeral key pair as the public key used to encrypt the symmetric key in the message key portion 32, or the ephemeral symmetric key used to encrypt the symmetric key in the message key portion 32. The decrypted symmetric key in the message key portion 32 can then be used to decrypt the message body 34. Use of an ephemerally decryptable symmetric key stored within a message header is desirable because this limits the amount of data that must be decrypted using the ephemeral decryption key. This is especially significant where the ephemeral decryption key is a private key of an ephemeral key pair, because decryption using a symmetric key is significantly less computationally intense than decryption using a private key. Accordingly, the amount of the message encrypted using the ephemeral public key may be minimized.

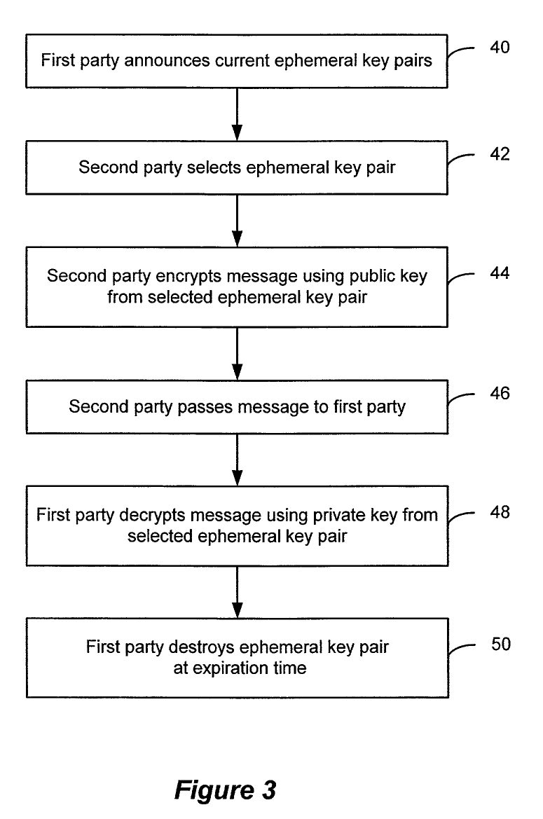

As shown in the flow chart of FIG. 3, in a first embodiment in which ephemeral public/private key pairs are employed, a first party may announce a current ephemeral key pair list at step 40. Alternatively at step 40, where ephemeral symmetric keys are employed, the first party may simply accept a request for an ephemeral symmetric key from a second party wishing to pass ephemeral data to the first party. The first party and second party described in connection with FIG. 3 may be software processes, personal computers, workstations, or any other type of devices which are capable of exchanging messages by way of a communications or messaging infrastructure such as a computer network or the Internet.

At step 42, in the case where ephemeral public/private key pairs are employed, the second party selects an ephemeral key pair from the ephemeral key pair list announced by the first party at step 40. If ephemeral symmetric keys are used, then at step 42 the second party receives an ephemeral symmetric key from the first party in response to the previous ephemeral key request. An ephemeral key pair list may include ephemeral key pairs having a variety of different associated expiration times, thus allowing the second party to select an ephemeral key pair having an associated expiration time adequate to both permit a particular message to be passed to the first party and permit the first party to read and/or otherwise process the message. The second party may provide a desired expiration time or expiration time range to the first party, causing the first party to provide an ephemeral key pair or ephemeral symmetric key having a requested expiration time. When an ephemeral symmetric key is provided to the second party, it should be conveyed in a secure manner, for example through a conventional encrypted tunnel mechanism.

At step 44, the second party encrypts the message using the ephemeral encryption key, for example either a public key from a selected ephemeral key pair, or a securely provided ephemeral symmetric key. To provide efficient processing, and because symmetric key encryption may be significantly more efficient than public key encryption, the second party may first encrypt the message body using a symmetric key, then encrypt that symmetric key using the ephemeral encryption key, and include the encrypted symmetric key as part of the message, for example in the message header. The message body may alternatively or additionally be encrypted using the ephemeral encryption key. At step 46, the second party passes the message to the first party via a communications or messaging infrastructure such as a computer network or the Internet.

At step 48, the first party decrypts the symmetric key in the message using an ephemeral decryption key, for example either the private key from the selected ephemeral key pair, or the ephemeral symmetric key previously provided to the second party. The first party further uses the decrypted symmetric key from the message to decrypt the message body. Where the message body was encrypted using the ephemeral encryption key, the first party uses the ephemeral decryption key to decrypt the message body. The first party then reads or otherwise processes the message without storing a decrypted copy of it that could later be discovered and read by an unauthorized party. At step 50 the first party destroys the ephemeral decryption key at the associated expiration time such that it cannot be recovered. Such a destruction capability may be provided in a hardware device which stores at least the ephemeral decryption keys and which only allows them to be read after receiving proof of a current time prior to the expiration time, or which erases the memory in which the ephemeral decryption keys are stored at their associated expiration times such that they cannot be recovered, for example by powering down a volatile memory in which the ephemeral keys are stored.

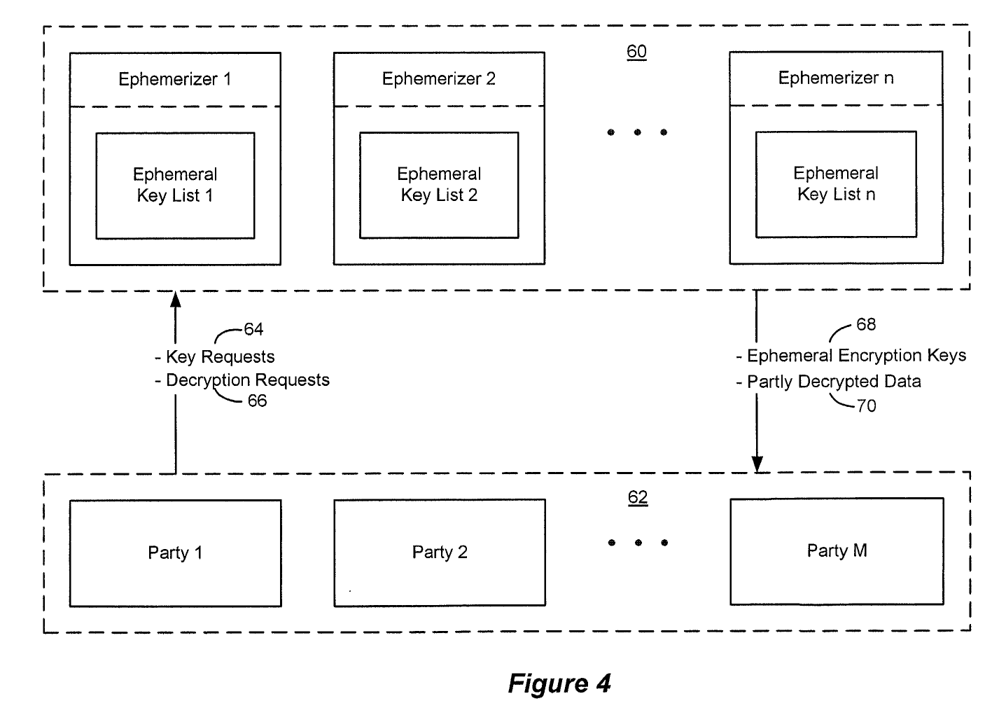

A second embodiment of the invention, as illustrated in FIG. 4, includes one or more ephemerizers 60 shown as Ephemerizer 1 through Ephemerizer N. Each of the ephemerizers 60 may supply ephemeral encryption keys to one or more of a number of parties 62. For example, one or more of the ephemerizers 60 may include an ephemeral key pair list, including expiration times associated with each ephemeral key pair, which is accessible to one or more of the parties 62. Further, one or more of the ephemerizers 60 may provide, upon request, ephemeral symmetric keys. The parties 62, shown as party 1 through party M, are communicative with the ephemerizers 60, via a communications or messaging infrastructure such as a computer network or the Internet. Each of the parties 62 and/or ephemerizers 60, may be a software process, personal computer, workstation, or any other type of device which is capable of exchanging messages by way of a communications or messaging infrastructure.

During operation of the components shown in FIG. 4, and as described in further detail with reference to FIG. 6, the parties 62 may read public keys from ephemeral key pairs made publicly accessible by the ephemerizers 60, and/or pass requests 64 for ephemeral keys having certain associated expiration times to the ephemerizers 60. The parties 62 also pass decryption requests 66 to the ephemerizers 60. The ephemerizers 60 may pass ephemeral encryption keys 68 and partly decrypted data 70 to the parties 62. The partly decrypted data 70 is “partly” decrypted in the sense that while it has been decrypted using an ephemeral decryption key by one of the ephemerizers 60, it may still require decryption using another decryption key which is unknown to that ephemerizer.

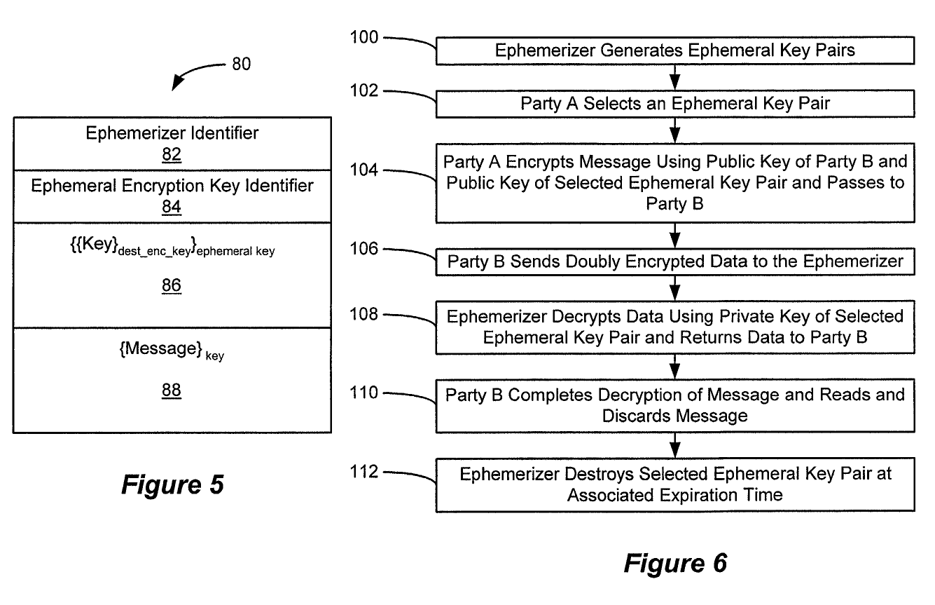

FIG. 5 shows an example of an ephemeral message format 80 applicable, for example, to the second embodiment of the invention as shown in FIG. 4. The ephemeral message format 80 includes an ephemerizer identifier 82 identifying one of the ephemerizers 60, such as a Uniform Resource Locator (URL), Internet Protocol (IP) address and port number combination, or other type of name or address information. The message format 80 further includes an ephemeral encryption key identifier 84, such as an index, remote reference, or pointer, for example indicating an ephemeral key pair within an ephemeral key pair list published by the ephemerizer identified by the ephemerizer identifier 82. Alternatively, the ephemeral encryption key identifier 84 may indicate an ephemeral symmetric key known by that ephemerizer. A message key portion 86 includes a symmetric key encrypted by both an encryption key of the destination party to which the message will be passed, as well as by the ephemeral encryption key indicated by the ephemeral encryption key identifier 84. The message body portion 88 is encrypted with the symmetric key included in the message key portion 86.

FIG. 6 illustrates steps performed during operation of the second embodiment of the invention. At step 100, in the case where ephemeral public/private key pairs are employed, an ephemerizer may make an ephemeral key pair list publicly available. However, in the case where ephemeral symmetric keys are provided by an ephemerizer, such keys would not be made publicly accessible, but would instead be provided in response to ephemeral key requests.

At step 102, Party A obtains an ephemeral encryption key, for example by selecting an ephemeral key pair from an ephemeral key pair list, or by receiving an ephemeral symmetric key provided by an ephemerizer in response to a previous ephemeral key request. The ephemeral encryption key may be selected or requested in such a way that it has an associated expiration time appropriate for a message Party A intends to pass to Party B. For example, Party A may select a publicly available ephemeral key pair having an appropriate associated expiration time. Alternatively, Party A may indicate a desired expiration time or range of times to the ephemerizer in a ephemeral key request, causing the ephemerizer to provide an ephemeral encryption key having the requested expiration time. Where the message to be passed is an electronic mail message, Party A may reasonably obtain an ephemeral encryption key associated with an expiration time that is one week in the future. Such a decryption lifetime would allow for the possibility that a recipient of the message may not check or read his or her received messages on a more frequent basis. The desired decryption period may also be calculated to take into consideration communication links and/or intermediate networking devices between Party A and Party B, which may become temporarily unusable, thus potentially delaying delivery of the message.

At step 104, Party A encrypts the message to be sent to Party B. Consistent with the message format 80 shown in FIG. 5, Party A encrypts the message body using a symmetric key, and doubly encrypts that symmetric key, first using an encryption key of Party B, and then applying the ephemeral encryption key to the result. Party A includes the doubly encrypted symmetric key in the message, as well as indications of the ephemerizer and ephemeral encryption key, and passes the complete message to Party B. Upon receipt of the message from Party A, at step 106, Party B sends the doubly encrypted symmetric key to the ephemerizer indicated within the message.

At step 108, the ephemerizer applies the appropriate ephemeral decryption key to the doubly encrypted symmetric key, for example using a private key from an ephemeral key pair also including the public key used as the ephemeral encryption key for the message. The result of this decryption is a copy of the symmetric key still encrypted by the encryption key of Party B. The ephemerizer passes this still encrypted symmetric key back to Party B, which then uses its own decryption key to complete decrypting the symmetric key at step 108. Party B uses the completely decrypted symmetric key to decrypt the body of the message. Party B assures that all reading or processing of the decrypted message is performed without storing a copy of the decrypted message that could later be read by an unauthorized party, and that all temporary copies of the decrypted message are irretrievably destroyed. The ephemerizer permanently destroys the ephemeral decryption key at the associated expiration time in step 112.

Other aspects and variations of the disclosed embodiments are now described. In both the first and second embodiment, ephemeral key pairs may be shared, in the sense that multiple encrypting parties may use the same public key from a given ephemeral key pair. Additionally, a public key of an ephemeral key pair may be used to encrypt multiple messages or files, by the same or different encrypting parties. As described above, message keys may be doubly encrypted to ensure ephemerizers cannot access fully decrypted message text. In the first embodiment (FIG. 3), ephemeral key pairs may be shared, even where messages or message keys are only singly encrypted with the public ephemeral key.

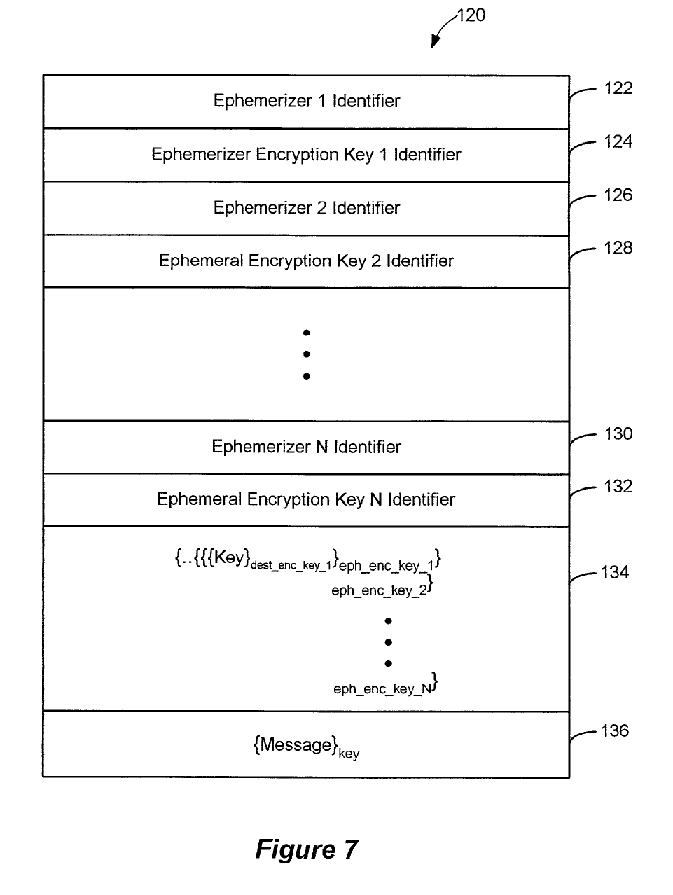

As illustrated by the ephemeral message format 120 shown in FIG. 7, multiple ephemerizers may be used to successively encrypt the message symmetric key, message body, or portions thereof. The ephemeral message format 120 includes a list of identifiers for N ephemerizers, together with identifiers for N associated ephemeral encryption keys. Specifically shown are ephemerizer 1 identifier 122, ephemeral encryption key 1 identifier 124, ephemerizer 2 identifier 126, ephemeral encryption key 2 identifier 128, and so forth through ephemerizer N identifier 130 and ephemeral encryption key N identifier 132. The message key portion 134 of the ephemeral message format 120 includes a symmetric key which was used to encrypt the message body 136, and which has been successively encrypted with each of the ephemeral encryption keys 1 through N of the ephemerizers 1 through N. Accordingly, in order to decrypt the message body 136, the receiver must use each of the ephemerizers 1 through N to successively decrypt the symmetric key in the message, so that the message body 136 may be decrypted using the decrypted symmetric key. Thus when multiple ephemerizers are used to provide encryption of a message in the message format 120, if at least one of the corresponding ephemeral private keys is destroyed at the associated expiration time, the message becomes completely un-decryptable at that time.

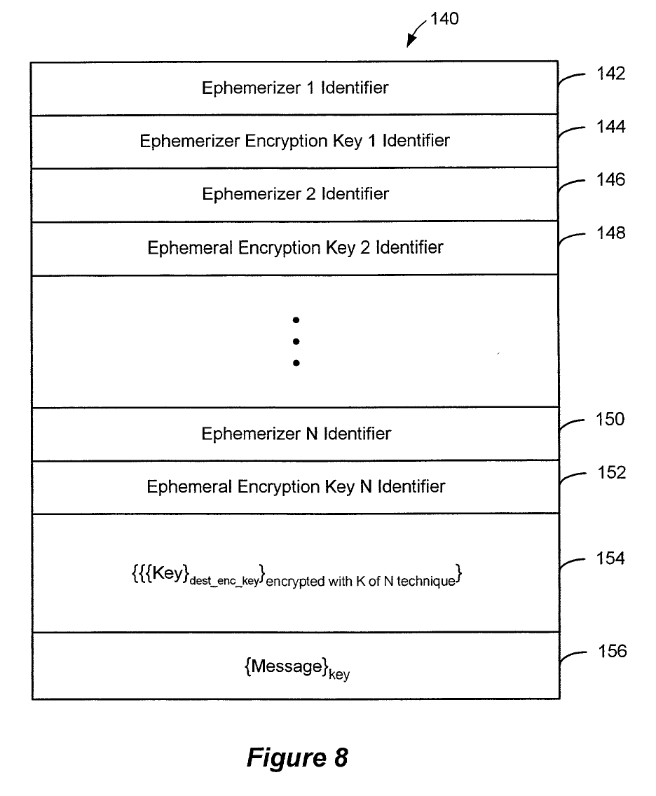

In another technique using multiple ephemerizers, and as illustrated by the ephemeral message format 140 shown in FIG. 8, a set of N ephemerizers may be used to encrypt a message key in a way that permits decryption using a subset of K ephemerizers of the N encrypting ephemerizers. Such an approach may exploit conventional “K of N” secret-sharing algorithms. The ephemeral message format 140 includes a list of identifiers for N ephemerizers, together with identifiers for N associated ephemeral encryption keys. Specifically shown are ephemerizer 1 identifier 142, ephemeral encryption key 1 identifier 144, ephemerizer 2 identifier 146, ephemeral encryption key 2 identifier 148, and so forth through ephemerizer N identifier 150 and ephemeral encryption key N identifier 152. The message key portion 134 of the ephemeral message format 140 includes a symmetric key which was used to encrypt the message body 156, and which has been encrypted with the ephemeral encryption keys 1 through N of the ephemerizers 1 through N, such that the decryption keys associated with only K of the ephemeral encryption keys 1 through N are necessary to decrypt it. Accordingly, the receiver of the message need only use K of the N ephemerizers used to encrypt the message to decrypt the message, enabling the message to be decrypted even in the case where up to N-K of the N encrypting ephemerizers either become unavailable, or forget the necessary ephemeral decryption keys prior to the appropriate expiration time.

As a further illustration of using multiple ephemerizers, an ephemeral message may be encrypted in j stages, using a series of j independent ephemerizer sets. At each stage, an ephemerizer set associated with that stage operates on the results from an ephemerizer set associated with the previous encryption stage. Each ephemerizer set may consist of a single necessary ephemerizer, multiple necessary ephemerizers, or multiple ephemerizers employing a K of N type encryption algorithm. Accordingly, the ephemerizer sets may be represented by the following expression:

{(K₁, N₁), (K₂, N₂) . . . (Kⱼ,Nⱼ)}

If Kᵢ=Nᵢ=1, then a single necessary ephemerizer is used at that stage, if Kᵢ=Nᵢ>1 then multiple necessary ephemerizers are used at that stage, and if Kᵢ<Nᵢ then Kᵢ of the Nᵢ ephemerizers in the set are necessary at that stage of decryption.

While the preceding alternatives are discussed with regard to encryption using a message key contained within the message to encrypt the message body, they are also applicable where the message body itself is encrypted, at least in part, using the ephemeral encryption key or keys. It is also possible to apply the disclosed system to messages which include multiple symmetric keys that are used to encrypt different portions of the message, or which are used in combination to encrypt the message multiple times. For example, a message format may be employed in which the message body is encrypted using a first symmetric key K₁. A version of K₁ that is encrypted using a public key of the message recipient is included in the message. A second symmetric key K₂ is then used to again encrypt K₁ and the message body. A version of K₂ that is encrypted using a first ephemeral encryption key is also included in the message. Another symmetric key K₃ may then be used to again encrypt K₂, K₁, and the message body. A version of K₃ encrypted with a second ephemeral encryption key is also included in the message. This type of ephemeral message format is extensible to employ as many symmetric keys within the message as are needed.

While in many circumstances the disclosed system may be preferably applied using ephemeral public/private key pairs, ephemeral symmetric keys may be desirable in some implementations or operational environments. Ephemeral symmetric keys may be used for single stage encryption using a single key, or as part of a multi-stage encryption using multiple keys. In multi-stage encryption, ephemeral symmetric keys may be used in combination with other types of ephemeral keys including public keys of ephemeral public/private key pairs.

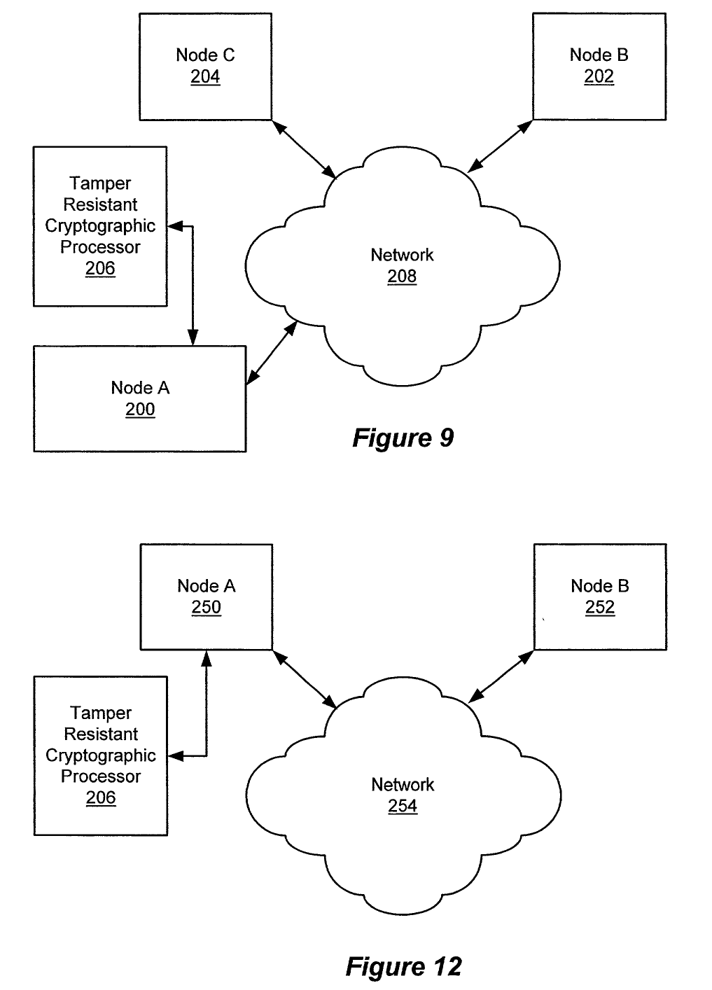

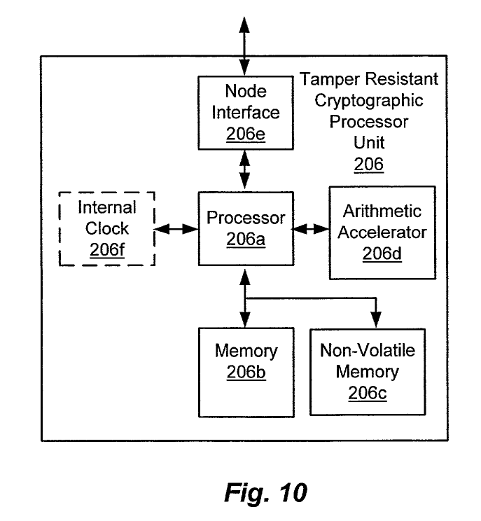

A further embodiment of the above-described system is described below that provides increased assurance that the ephemeral keys are extinguished; i.e. erased or made inaccessible. A three party system is depicted in FIG. 9 in which one of the nodes in conjunction with a tamper resistant cryptographic processor unit serves as an ephemerizer and the other two nodes are involved in message communication. Referring to FIG. 9, the system includes a first node identified as Node A 200 that is communicably coupled to a tamper resistant cryptographic processor unit 206 via a suitable communication interface. Node A 200, a second node identified as Node B 202, and a third node identified as Node C 204 are communicably coupled via a Network 208. The tamper resistant cryptographic processor 206 is operative to generate and store ephemeral key pairs along with an expiration time for each key pair. A block diagram of an illustrative tamper resistant cryptographic processor 206 is depicted with greater particularity in FIG. 10. The tamper resistant cryptographic processor unit 206, in a preferred embodiment, comprises a programmable device that is operative to perform the functions herein described. The cryptographic processor unit 206 becomes inoperative in the event a user attempts to access information within the device by disassembly or via unauthorized access to information stored within the unit 206. Moreover, ephemeral keys stored within the tamper resistant cryptographic processor unit 206 may be extinguished upon detection of temperatures above or below predetermined thresholds or upon detection of applied voltages above or below predetermined thresholds or upon detection of other conditions that are considered as threats to the security or integrity of ephemeral keys stored within the tamper resistant cryptographic processor unit 206.

Referring to FIG. 10, the tamper resistant cryptographic processor 206 includes a processor 206a that is coupled to a first memory 206b and a second non-volatile memory 206c. The processor 206a is also coupled to an arithmetic accelerator 206d and a node interface 206e for communicably coupling the tamper resistant cryptographic processor 206 to Node A 200. While the processor 206a and arithmetic accelerator 206d are depicted as separate blocks in FIG. 10 it should be appreciated that the processor 206a and the arithmetic accelerator 206d may be combined in a single functional unit. The tamper resistant cryptographic processor 206 stores ephemeral keys in the non-volatile memory 206c. The tamper resistant cryptographic processor 206 may optionally include an internal clock 206f. The use of the internal clock 206f is discussed below.

The tamper resistant cryptographic processor may comprise a commercially available smart card that is programmed to provide the presently described functionality. Suitable smart cards are commercially available from Gem Plus, International S.A. of Senningerberg, Luxembourg and Schlumberger Limited of Austin, Tex. It is noted however, that the commercially available smart cards do not include a mechanism for assuring the erasure or inoperability of stored keys following a predetermined time.

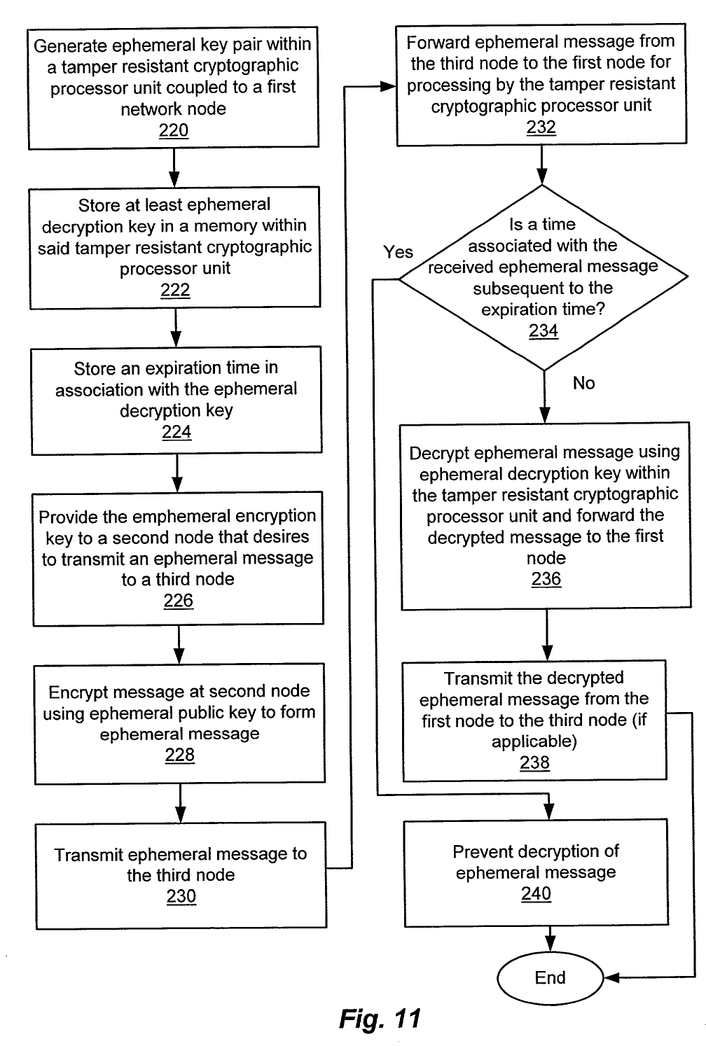

The operation of the system depicted in FIG. 9 is illustrated in the flow diagram of FIG. 11. Referring to FIG. 11, the tamper resistant cryptographic processor 206 generates an ephemeral key pair comprising an ephemeral encryption key and an ephemeral decryption key as depicted in step 220. The ephemeral key pair preferably comprises a public/private key pair. The public key serves as the encryption key and the private key serves as the decryption key. At least the ephemeral decryption key is stored within the memory 206c within the tamper resistant encryption processing unit 206 as illustrated in step 222 and the ephemeral decryption key is not communicated external to the cryptographic processor unit 206. A specified expiration time is associated with at least the ephemeral decryption key as illustrated in step 224. The expiration time specifies the time subsequent to which messages encrypted with the applicable ephemeral encryption key may no longer be decrypted. The expiration time is stored in association with the respective ephemeral decryption key, preferably within the cryptographic processor unit 206.

Ephemeral key pairs having different expiration times may be generated in advance of use or alternatively, in the event an ephemeral key pair having a specified expiration time is needed, such may be generated within the cryptographic processor unit in response to a request.

Assuming for purposes of illustration that Node B 202 desires to transmit an ephemeral message to Node C 204 that is no longer accessible after a specified expiration time, an ephemeral encryption key associated with the desired expiration time is communicated to Node B as depicted in step 226. Node B 202 then encrypts its message with a first encryption key for which Node C 204 holds the corresponding first decryption key. These first encryption and decryption keys may comprise a public/private key pair owned by Node C 204. Alternatively, the first encryption and decryption keys may comprise symmetric keys. Node B 202 then encrypts the message encrypted with the first encryption key with the ephemeral encryption key to form an ephemeral message as depicted in step 228. The ephemeral message is then forwarded to Node C 204 from the second node 202 as depicted in step 230. The ephemeral message may include an address of the ephemerizer (Node A) in the form of a uniform resource locator (URL) or any other suitable identification to facilitate the forwarding of information from Node C to Node A for decryption by the ephemerizer.

The ephemeral message or information within the message that is desired to be decrypted is then passed from Node C 204 to Node A 200 for communication to the tamper resistant cryptographic processor unit 206 as depicted in step 232. The forwarded message may optionally include a timestamp corresponding to the time of message transmission and an ephemeral key identifier that was obtained with the ephemeral public key. The use of such information is discussed later. A determination is next made by the cryptographic processor unit 206 whether a time associated with the message received at Node A or the tamper resistant cryptographic processor 206 is subsequent to the expiration time for the respective ephemeral key pair as depicted in step 234.

The time associated with the received message (message time) may be obtained in a number of ways. First, the time associated with the received message may comprise a time stamp that is included in the message communicated from Node C 204 to Node A. Second, the time associated with the received message may be generated upon receipt of the ephemeral message at the tamper resistant cryptographic processor unit 206 via use of the internal clock 206f. The generation of the time in this manner reduces the possibility that an ephemeral message may be forwarded to the cryptographic processor unit 206 with a backdated timestamp. Provision of the internal clock 206f within the tamper resistant cryptographic processor unit 206 also permits the cryptographic processor unit to purge expired ephemeral keys from the non-volatile memory 206c upon the expiration of each ephemeral key pair. Third, the time that is associated with the received message may be obtained from a trusted authority. In this circumstance, upon receipt of a message at Node A 200 or the tamper resistant cryptographic processor unit 206, a request is issued to the time authority to return the time. The request may include a nonce (a special identifier). The trusted time authority forwards to Node A 200 or the tamper resistant cryptographic processor unit 206, as applicable, a message that includes the current time and the nonce signed by the trusted time authority. The inclusion of the nonce within the request and the return message allows Node A or the tamper resistant cryptographic processor unit 206, as applicable, to detect replays of previously transmitted time messages since the nonce in the replayed time message will not match the nonce transmitted in a more current time request. As used herein, it should be understood that the term time or time stamp are used to denote a date and time.

The granularity of the message time may vary in different applications. For example, the message time may be generated from a real time clock and the granularity of the message time may be highly precise in the range of milliseconds or less, tenths of second, or may be provided in seconds, minutes, hours, days, weeks, months or any other suitable granularity. Similarly, the expiration time may be specified with any suitable granularity.

The cryptographic processor unit 206 may use the ephemeral key pair identifier within the received message to identify the applicable expiration time and ephemeral decryption key. If the time associated with the received message is not subsequent to the expiration time for the respective ephemeral key pair, the cryptographic processor unit uses the applicable ephemeral decryption key to decrypt the ephemeral message and forwards the decrypted ephemeral message to Node A 200 as depicted in step 236. The decrypted ephemeral message is then forwarded from Node A 200 to Node C 204 as depicted in step 238. Node C 204 may then decrypt the decrypted ephemeral message using the Node C 204 decryption key.

In the event it is determined in step 234 that the time associated with the received message is subsequent to the expiration time for the respective ephemeral key pair, as depicted in step 240, the tamper resistant cryptographic unit 206 does not return a decrypted ephemeral message to Node A 200. Additionally, upon recognition that the time associated with the received message is subsequent to the expiration time for the respective ephemeral key pair or upon recognition that the time indicated by the internal clock 206f (FIG. 10) is subsequent to the expiration time for a particular ephemeral key pair, at least the ephemeral decryption key may be erased thereby further reducing the possibility that ephemeral messages may be decrypted subsequent to the associated expiration time.

A two party ephemerizer system is depicted in FIG. 12. The system includes a first node identified as Node A 250 communicably coupled to a second node identified as Node B 252 via a network 254. Only two nodes are shown for simplicity although it should be recognized that additional nodes might be coupled to the network 254. In the illustrated system, Node A 250 in conjunction with the cryptographic processor unit 206 comprises an ephemerizer. Node A 250 and Node B 252 can interchange ephemeral messages as discussed above in conjunction with the flow diagram of FIG. 11. Assuming Node B 252 desires to transmit an ephemeral message to Node A 250, operation would proceed as discussed with respect to FIG. 11 noting that the first and third nodes comprise the same node.

It will be appreciated by those of ordinary skill in the art that the ephemeral public key along with an optional ephemeral key pair identifier may be provided to a node within the network in response to a request to the ephemerizer. Alternatively, the ephemeral public key and the optional ephemeral key pair identifier may be provided to a directory service and accessed by a node via a directory server (not shown) as known in the art, or via any other suitable key distribution technique known in the art.

Additionally, while the tamper resistant cryptographic processor unit 206 is illustrated as being coupled to the network 208 via a single node 200, it should be appreciated that the tamper resistant cryptographic processor unit 206 may be coupled to the network 208 via multiple processors or nodes. In such event, the tamper resistant cryptographic processor unit 206 may receive a message for decryption from one of the nodes and forward the decrypted message to a second one of the nodes.

It should further be appreciated that the ephemeral message may comprise an encrypted information message such as email, data, a decryption key or any other form of encrypted information.

Additionally, it should be appreciated that any messages forwarded from one node to another node in accordance with the presently disclosed system and method may be signed by the node or entity forwarding the message and verified by the receiving node.

Furthermore while in the above-described embodiment, an expiration time associated with an ephemeral key pair is provided in the form of the date and time for expiration of the respective ephemeral key pair, in an alternative embodiment, the expiration time associated with the ephemeral key pair may be defined via a time period. For example, a time period of 14 days may be associated with an ephemeral key pair and the time period may be counted down using an internal clock or tested against an internal clock to determine when the respective ephemeral key pair has expired.

Moreover, while in a preferred embodiment, the nodes are communicably coupled via a network, the nodes need not be coupled via a network. In the event one or more nodes are not coupled via a network, the messages may be obtained from one node in the prescribed form and delivered via any suitable means to another node for processing as described herein.

With regard to ephemerizer business models, the ephemerizer service of the second embodiment may be designed to charge for use of ephemeral key pairs, or for the decryption service provided to the recipient of a message encrypted with an ephemeral public key. Such charging may, for example be based on message size or average number of messages over time.

Those skilled in the art should readily appreciate that the programs defining the functions herein described can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks, re-writable compact disks and hard drives); or (c) information conveyed to a computer through communication media for example using baseband signaling or broadband signaling techniques, including carrier wave signaling techniques, such as over computer or telephone networks via a modem. Additionally, wireless communication techniques may be employed for communication of the programs described herein. In addition, while the invention may be embodied in computer software, the functions necessary to implement the invention may alternatively be embodied in part or in whole using hardware components such as Application Specific Integrated Circuits or other hardware, or some combination of hardware components and software.

In an exemplary hardware platform on which a software-based implementation of the present invention would execute, the program code executes on one or more processors, for example a microprocessor. The program code may be stored in, and may be executed on the processor from a memory such as a Random Access Memory (RAM) or Read Only Memory (ROM). The memory storing the program code is communicable with the processor, for example by way of a memory bus. In addition, the exemplary platform may include various input/output (I/O) devices, such as a keyboard and mouse, as well as secondary data storage devices such as magnetic and/or optical disks. As mentioned above, a destruction capability may be provided in a hardware device which stores at least the ephemeral decryption keys and which only allows them to be read after receiving proof of a current time prior to the expiration time, or which erases the memory in which the ephemeral decryption keys are stored at their associated expiration times such that they cannot be recovered, for example by powering down a volatile memory in which the ephemeral keys are stored.

It should further be appreciated by those of ordinary skill in the art that the tamper resistant cryptographic processor units herein described may be employed in the above-described systems employing multiple ephemerizers.

While the invention is described through the above exemplary embodiments, it will be understood by those of ordinary skill in the art that modification to and variations of the illustrated embodiments may be made without departing from the inventive concepts herein disclosed. Specifically, while the preferred embodiments are disclosed with reference to messages passed between users of a computer network, the invention may be employed in any context in which messages are passed between communicating entities. Moreover, while the preferred embodiments are described in connection with various illustrative data structures, one skilled in the art will recognize that the system may be embodied using a variety of specific data structures. Accordingly, the invention should not be viewed as limited except by the scope and spirit of the appended claims.

What is claimed is:

1. A method for performing ephemeral decryption comprising:
associating an expiration time with at least an ephemeral decryption key of an ephemeral key pair comprising said ephemeral decryption key and an ephemeral encryption key;
storing at least said ephemeral decryption key in a memory within a tamper resistant cryptographic processor unit such that said ephemeral decryption key is not accessible external of said tamper resistant cryptographic processor unit;
receiving at said tamper resistant cryptographic processor unit from a first node an ephemeral message encrypted with said ephemeral encryption key; and
decrypting said ephemeral message within said tamper resistant cryptographic processor unit using said ephemeral decryption key to form a decrypted ephemeral message in the event said ephemeral message is associated with a message time that is prior to said expiration time.

2. The method of claim 1 further including the step of forwarding said decrypted ephemeral message to said first node.

3. The method of claim 1 further including the step of forwarding said decrypted ephemeral message to a second node.

4. The method of claim 1 further including the step of generating said ephemeral key pair within said tamper resistant cryptographic processor unit.

5. The method of claim 1 further including the step of extinguishing at least said ephemeral decryption key following the associated expiration time to prevent said ephemeral message from becoming accessible subsequent to said expiration time.

6. The method of claim 5 wherein said extinguishing step comprises the step of erasing said ephemeral decryption key.

7. The method of claim 5 wherein said extinguishing step comprises the step of preventing messages that are decrypted using said ephemeral decryption key from being forwarded outside of said tamper resistant cryptographic processor unit.

8. The method of claim 5 wherein said extinguishing step comprises the step of preventing messages that are encrypted using said encryption key from being decrypted using said ephemeral decryption key.

9. The method of claim 1 further including the step of erasing said ephemeral decryption key within said tamper resistant cryptographic processor unit in the event said message time is subsequent to said expiration time.

10. The method of claim 1 wherein said tamper resistant cryptographic processor unit includes an internal clock operative to generate said message time and said method includes the step of erasing said ephemeral decryption key in response to a determination that said message time is subsequent to said expiration time.

11. The method of claim 1 wherein said message time corresponds to a timestamp accompanying said received ephemeral message.

12. The method of claim 1 wherein said message time corresponds to a timestamp generated by a clock within said tamper resistant cryptographic processor unit.

13. The method of claim 1 wherein said message time corresponds to a time received from a trusted time authority.

14. The method of claim 13 further including the steps of:
in response to receipt of said ephemeral message at said tamper resistant cryptographic processor unit, forwarding a request to said trusted time authority for said message time;
receiving a time message including said message time from said trusted time authority; and
associating said message time with said ephemeral message.

15. The method of claim 14 further including the steps of:
signing by said trusted time authority said time message; and
verifying said signed time message.

16. The method of claim 1 further including the step of erasing at least said ephemeral decryption key upon detection within said tamper resistant cryptographic processor unit of a predetermined condition indicative of an attempt to access at least said ephemeral decryption key.

17. The method of claim 1 wherein said first node is coupled to a global communications network.

18. The method of claim 1 wherein said first node is coupled to a local area network.

19. A method for communicating an ephemeral message comprising:
associating an expiration time with at least an ephemeral decryption key of an ephemeral key pair including said ephemeral decryption key and an ephemeral encryption key;
storing at least said ephemeral decryption key in a memory within a tamper resistant cryptographic processor unit in communication with a first node such that said ephemeral decryption key is not accessible external of said tamper resistant processor unit;
encrypting at a second node a message to form an encrypted ephemeral message, wherein said encrypting is performed using said ephemeral encryption key;
in a first transmitting step, transmitting said ephemeral message to a third node;
forwarding by said third node to said tamper resistant cryptographic processor unit via said first node said encrypted ephemeral message;
decrypting said encrypted ephemeral message within said tamper resistant cryptographic processor unit using said ephemeral decryption key in the event said message is associated with a message time prior to said expiration time;
forwarding said decrypted ephemeral message from said tamper resistant cryptographic processor cryptographic processor unit to a fourth node; and
in a second transmitting step, transmitting said decrypted ephemeral message from said fourth node to said third node.

20. The method of claim 19 wherein said first node and said fourth node are the same node.

21. The method of claim 19 further including the step of generating said ephemeral key pair within said tamper resistant cryptographic processor unit.

22. The method of claim 19 wherein said encrypting step includes the steps of encrypting said message at said second node with a third node encryption key having a corresponding third node decryption key held by said third node and encrypting said message encrypted using said third node encryption key using said ephemeral encryption key to form said encrypted ephemeral message; and
following said second transmitting step, decrypting said decrypted ephemeral message using said third node decryption key to reproduce said message.

23. An apparatus for use in ephemeral communications comprising:
a tamper resistant cryptographic processor unit including a memory, said unit operative to:
associate an expiration time with at least an ephemeral decryption key of an ephemeral key pair including an ephemeral encryption key and said ephemeral decryption key;
store at least said ephemeral decryption key in said memory such that said ephemeral decryption key is not accessible external of said tamper resistant cryptographic processor unit;
receive from a first node coupled to a network at said tamper resistant cryptographic processor unit an ephemeral message that has been encrypted with said ephemeral encryption key;
decrypt said encrypted ephemeral message within said tamper resistant cryptographic processor unit using said ephemeral decryption key in the event said message is associated with a message time related to the time of receipt of said encrypted ephemeral message prior to said expiration time; and
forward said decrypted message to a second node.

24. The apparatus of claim 23 wherein said first node and said second node are the same node.

25. The apparatus of claim 23 wherein said tamper resistant cryptographic processor unit is operative to generate said ephemeral key pair including said ephemeral encryption key and said corresponding ephemeral decryption key within said tamper resistant cryptographic processor unit.

26. The apparatus of claim 23 wherein said tamper resistant cryptographic processor unit is further operative to extinguish said ephemeral decryption key in response to a determination that said message time is subsequent to said expiration time.

27. The apparatus of claim 26 wherein said tamper resistant cryptographic processor unit is operative to erase said ephemeral decryption key in response to a determination that said message time is subsequent to said expiration time.

28. The apparatus of claim 26 wherein said tamper resistant cryptographic processor unit is operative to prevent decrypted ephemeral messages from being forwarded to the second node in response to said determination that said message time is subsequent to said expiration time.

29. The apparatus of claim 26 wherein said tamper resistant cryptographic processor unit is operative to prevent said encrypted ephemeral message from being decrypted using said ephemeral decryption key in response to a determination that said message time is subsequent to said expiration time.

30. The apparatus of claim 23 wherein said tamper resistant cryptographic processor unit is operative to erase said ephemeral decryption key within said tamper resistant processor unit in the event said received ephemeral message includes a timestamp that is subsequent to said expiration time.

31. The apparatus of claim 23 wherein said tamper resistant cryptographic processor unit further includes an internal clock and said tamper resistant cryptographic processor unit is operative to erase said ephemeral decryption key within said tamper resistant cryptographic processor unit in response to a determination that a clock time generated by said internal clock in response to receipt of said ephemeral message is subsequent to said expiration time.

32. The apparatus of claim 23 wherein said tamper resistant cryptographic processor unit is operative to retrieve said message time from a trusted time authority and said tamper resistant cryptographic processor unit is operative to erase said ephemeral decryption key in the event said message time is subsequent to said expiration time.

33. The apparatus of claim 23 wherein said tamper resistant cryptographic processor unit is operative to erase at least said ephemeral decryption key in response to detection of a predetermined condition indicative of an attempt to access information within said tamper resistant cryptographic processor unit.

34. The apparatus of claim 23 wherein said tamper resistant cryptographic processor unit is operative to erase said ephemeral decryption key in response to detection of a predetermined condition indicative of an attempt to access said ephemeral decryption key.

35. A computer program product including a computer readable medium, said computer readable medium having a computer program stored thereon for use in ephemeral communication, said computer program being executable on a processor and comprising:
program code for associating an expiration time with at least an ephemeral decryption key of an ephemeral key pair including said ephemeral decryption key and a corresponding ephemeral encryption key;
program code for storing at least said ephemeral decryption key in a memory within a tamper resistant cryptographic processor unit such that said ephemeral decryption key is not accessible external of said tamper resistant cryptographic processor unit;
program code for receiving at said tamper resistant cryptographic processor unit from a first node an ephemeral message encrypted with said ephemeral encryption key; and
program code for decrypting said ephemeral message within said tamper resistant cryptographic processor unit using said ephemeral decryption key to form a decrypted ephemeral message in the event said message is associated with a message time prior to said expiration time.

36. The computer program product of claim 35 wherein said computer program further includes program code for forwarding said decrypted ephemeral message to said first node.

37. The computer program product of claim 35 wherein said computer program further includes program code for forwarding said decrypted ephemeral message to a second node.

38. A computer data signal, said computer data signal including a computer program for use in ephemeral communication, said computer program comprising:
program code for associating an expiration time with at least an ephemeral decryption key of an ephemeral key pair including said ephemeral decryption key and an ephemeral encryption key;
program code for storing at least said ephemeral decryption key in a memory within a tamper resistant cryptographic processor unit such that said ephemeral decryption key is inaccessible external of said tamper resistant cryptographic processor unit;
program code for receiving at said tamper resistant cryptographic processor unit from a first node an ephemeral message encrypted with said ephemeral encryption key; and
program code for decrypting said ephemeral message within said tamper resistant cryptographic processor unit using said ephemeral decryption key to form a decrypted ephemeral message in the event said message is associated with a message time prior to said expiration time.

39. The computer data signal of claim 38 wherein said computer program further includes program code for forwarding said decrypted ephemeral message to said first node.

40. The computer data signal of claim 38 wherein said computer program further includes program code for forwarding said decrypted ephemeral message to a second node.

41. An apparatus for use in ephemeral communication of information comprising:
means for associating an expiration time with at least an ephemeral decryption key of an ephemeral key pair including said ephemeral decryption key and a corresponding ephemeral encryption key;
means for storing at least said ephemeral decryption key in a memory within said tamper resistant cryptographic processor unit such that said ephemeral decryption key is not accessible external of said tamper resistant cryptographic processor unit;
means for receiving at said tamper resistant cryptographic processor unit from a first node an ephemeral message encrypted with said ephemeral encryption key; and
means for decrypting said ephemeral message within said tamper resistant cryptographic processor unit using said ephemeral decryption key in the event said message is associated with a message time prior to said expiration time.

42. A method for performing ephemeral decryption comprising:
associating an expiration time with at least an ephemeral decryption key of an ephemeral key pair comprising said ephemeral decryption key and an ephemeral encryption key;
storing at least said ephemeral decryption key in a memory within a tamper resistant cryptographic processor unit such that said ephemeral decryption key is not accessible external of said tamper resistant cryptographic processor unit;
comparing a time stamp associated with an encrypted ephemeral message with said expiration time, wherein said encrypted ephemeral message is encrypted with said ephemeral encryption key; and
decrypting said encrypted ephemeral message within said tamper resistant cryptographic processor unit using said ephemeral decryption key if said time stamp is prior to said expiration time.

43. A method for employing ephemeral keys comprising:
associating a time duration defined by an initial value and an ending value with at least an ephemeral decryption key of an ephemeral key pair comprising said ephemeral decryption key and an ephemeral encryption key;
storing at least said ephemeral decryption key in a memory within a tamper resistant cryptographic processor unit such that said ephemeral decryption key is not accessible external of said tamper resistant cryptographic processor unit;
modifying said duration value in a predetermined manner between said initial value and said ending value;
extinguishing at least said ephemeral decryption key within said tamper resistant cryptographic processor unit after said duration value reaches said ending value.

44. The method of claim 43 further including the steps of:
receiving at said tamper resistant cryptographic processor unit an ephemeral message encrypted with said ephemeral encryption key; and
decrypting said ephemeral message within said tamper resistant cryptographic processor unit in the event said duration value has not reached said ending value.

45. The method of claim 43 wherein the difference between said initial value and said ending value corresponds to a time period until expiration of said ephemeral key pair, said ending value equals 0 and said modifying step comprises the step of decrementing said initial value generally periodically until said ending value of 0 is reached.
